(19) United States
(12) Patent Application Publication
(10) Pub. No.: US 2018/0370172 A1
(43) Pub. Date: Dec. 27, 2018

(54) SCRAP PRESSING AND COMPACTING APPARATUS, AND CORRESPONDING METHOD

(71) Applicant: Colombo Giovanni S.R.L, Daverio (IT)

(72) Inventor: Claudio Colombo, Varese (IT)

(21) Appl. No.: 15/741,401

(22) PCT Filed: Jul. 1, 2016
(86) PCT No.: PCT/IB2016/053986

§ 371 Date: Jan. 2, 2018

(30) Foreign Application Priority Data
Jul. 3, 2015 (IT) 102015000030718

(51) Int. Cl. B30B 9/32; B30B 15/32; B30B 7/02

(52) U.S. Cl. CPC B30B 9/32; B65F 2210/162; B30B 7/023; B30B 15/32

(57) ABSTRACT

Pressing and compacting apparatus comprising a support body, a presser mean pivoted to the support body, an actuation member connected to said presser mean and configured to move the presser mean toward/away from the support body, and a detection device associated to the presser mean to detect the angular position of the presser mean.

### FIELD OF THE INVENTION

The present invention concerns an apparatus and a corresponding method for pressing and compacting a loose and incoherent mass of scrap.

In particular, the present invention concerns an apparatus and the corresponding method for detecting the position of presser means of the pressing and compacting apparatus used for pressing and compacting a mass of metal scrap, such as automobile parts, tanks, collected materials, or other materials, for example non-metallic or mixed.

### BACKGROUND OF THE INVENTION

Different apparatuses and methods are known, configured to reduce the volume occupied by scrap into a compact mass with a desired section, and then to further compact it into packs and/or to divide it into blocks, so that it can then be sent or discharged to subsequent steps, for example recycling or melting.

Known pressing and compacting apparatuses usually comprise two presser means, or pressing lids, pivoted with respective pivoting pins to a base, and selectively rotatable with respect to the latter between a first position for receiving the scrap, in which the presser means and the base define a cavity for receiving the scrap, and a second compacting position, in which the presser means are rotated nearer to the base in order to press the mass of scrap present between them and to compact it.

Known pressing apparatuses usually comprise linear actuators, fixed with a first end to the base and a second end to one of the presser means.

Actuating the linear actuators determines the rotation of the presser means around the pivoting pins of the presser means.

During the actuation of the linear actuators, the latter are also subjected to a rotation around their first end.

It is also known to provide detection devices to detect, instant by instant, the position assumed by the presser means during the scrap pressing and compacting operations.

It is indispensable to detect the position of the presser means in order to correctly perform the scrap pressing and compacting operations.

The detection devices can be associated directly with the linear actuators to detect their movement and, depending on the data detected, to determine the position assumed by the presser means.

One solution is known in which the detection devices comprise rotary transducers, such as rotary encoders, installed directly on the linear actuators and configured to detect the angular position of the latter. Depending on the angular position of the linear actuators, the position of the presser means is then determined.

However, rotary transducers are not very accurate in determining the position of the presser means because with a slight rotation of the linear actuators around their first end there is a corresponding high angular travel of the presser means.

Another disadvantage typical of rotary transducers is that it is difficult to detect the position of the presser means since the same measurement detected by the rotary transducer can correspond to two different angular positions of the same presser mean, because two different positions of the corresponding presser mean can correspond to the same value of extension of the actuation member.

A solution is also known in which, to detect the position of the presser means, position transducers are used, such as linear encoders, installed directly on the linear actuators and which, depending on the linear travel to which the latter are subjected, allow to detect the position of the presser means.

Linear encoders of this type can also be installed inside the corresponding linear actuator, for example on the head of the cylinder and/or the plunger. This causes high costs of installation, maintenance and possible replacement of the detection devices present inside the linear actuator, because it is difficult to access them.

Furthermore, installing the detection devices inside the linear actuators can cause damage to the detection devices themselves, if the linear actuators are commanded to make an extra travel to determine a further compacting of the scrap.

In fact, the entity of the extra travel can determine violent impacts on components of the linear actuators, with consequent damage to the detection devices.

There is therefore a need to perfect an apparatus and a method for pressing and compacting scrap which can overcome at least one of the disadvantages of the state of the art.

In particular, one purpose of the invention is to obtain a pressing and compacting apparatus for scrap which allows to detect easily and accurately the position of the presser means.

Another purpose of the present invention is to provide a scrap pressing and compacting apparatus that is simple and economical.

Another purpose of the present invention is to provide a scrap pressing and compacting apparatus that is precise and reliable.

Another purpose of the present invention is to provide a scrap pressing and compacting apparatus that is long-lasting and easily maintained.

Another purpose of the present invention is to make the detection devices easily accessible for maintenance/repairs or possible replacement.

Another purpose of the present invention is to provide a scrap pressing and compacting apparatus that detects univocally and precisely the position of the presser means.

Furthermore, one purpose of the present invention is to provide a scrap pressing and compacting apparatus that is practical and efficient.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the present invention or variants to the main inventive idea.

In accordance with the above purposes, a pressing and compacting apparatus according to the present invention comprises:
at least one support body;
at least one presser mean pivoted to the support body;
at least one actuation member connected to the presser mean and configured to move the presser mean toward/away from the support body to assume respectively a scrap compacting position and a scrap reception position;
at least one detection device associated to the presser mean to detect the angular position of the presser mean.

In accordance with one aspect of the present invention, the detection device comprises at least one connection mechanism pivoted with a first end to the presser mean and with a second end to the support body, and at least one angular detection member associated to the second terminal portion to detect an angular travel of the connection mechanism.

This solution allows to simplify the angular detection operations of the presser means, since it is possible to position and configure the connection mechanism in one position and advantageously to detect precisely the angular position of the presser means.

In accordance with some embodiments, the connection mechanism comprises a first oblong element and at least one second oblong element pivoted to each other. The first oblong element is pivoted to the presser mean and the second oblong element is pivoted to the support body. The first oblong element and the second oblong element are also configured to make the connection mechanism assume a univocal position for each position of the presser mean.

This condition prevents that two or more positions of the at least one presser mean can correspond to the same position assumed by the connection mechanism. This allows to simplify the position detections, preventing possible imprecisions in detection.

The present invention also concerns a scrap pressing and compacting method that comprises:
the selective drive of at least one actuation member to rotate at least one pressure mean with respect to a support body and take it into a reception position suitable to allow the introduction of the scrap into the support body and into the presser mean, and into a compacting position suitable to compact the scrap between the presser mean and the support body; and
the detection of the position of the at least one presser mean.

In accordance with one aspect of the detection method according to the present invention, it comprises detecting the angular travel of a connection mechanism pivoted with a first end to the presser mean and with a second end to the support body and, as a function of the angular travel of the connection mechanism, calculating the position of the presser mean.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a schematized/simplified front view of a scrap pressing and compacting apparatus in accordance with embodiments described here;

FIG. 2 is a schematized/simplified front view of a detection device of a scrap pressing and compacting apparatus in accordance with other embodiments described here;

FIGS. 3 to 6 are schematized/simplified front views of a scrap pressing and compacting apparatus in accordance with other embodiments described here;

FIG. 7 is a schematized/simplified front view of a scrap pressing and compacting apparatus in accordance with other embodiments described here;

FIG. 8 is a schematized/simplified front view of a detection device of a scrap pressing and compacting apparatus, in two operating positions, in accordance with other embodiments described here;

FIG. 9 is a schematized/simplified front view of an end-of travel detector of a scrap pressing and compacting apparatus in accordance with other embodiments described here;

FIG. 10 is a schematized/simplified front view of an end-of travel detector of a scrap pressing and compacting apparatus in accordance with other embodiments described here;

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

FIG. 1 is used to describe example embodiments of a pressing and compacting apparatus 10, according to the present invention, used to press and compact a loose mass 28 of scrap in order to reduce it to a pre-established volume.

In accordance with possible embodiments, the pressing and compacting apparatus 10 comprises a support body 30 suitable to receive and support the scrap before and during the compacting operations.

The support body 30 can be provided on the upper part with a pressing base 16 on which the scrap is disposed.

In accordance with variant embodiments, described using FIG. 1, the base 16 can have, by way of example, a flat cross section.

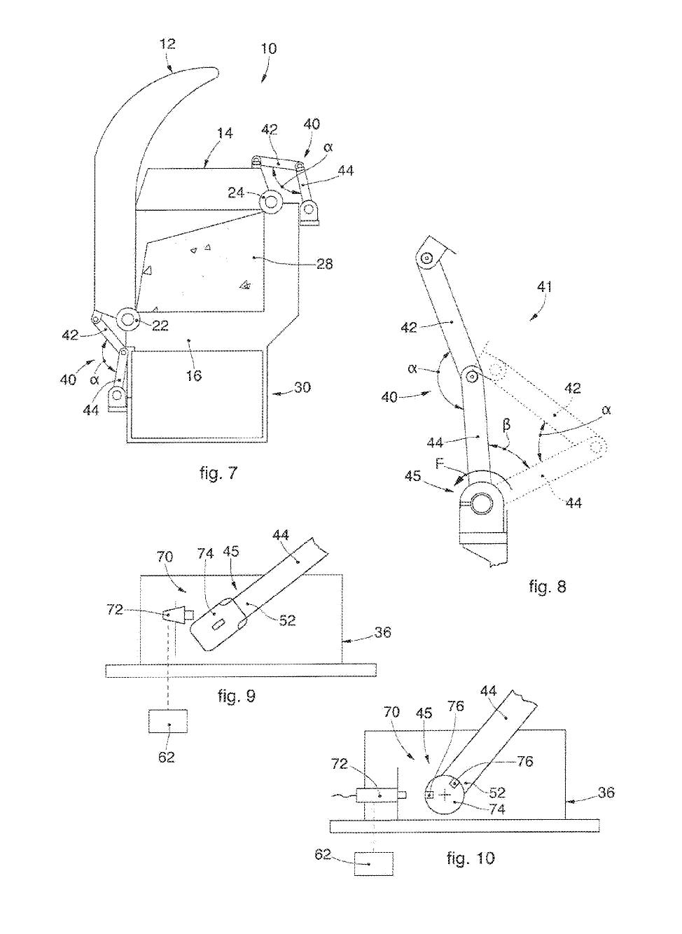

In accordance with variant embodiments, described using FIG. 7, the base 16 can have, by way of example, a substantially “L” shaped cross section.

In accordance with one aspect of the present invention, the pressing and compacting apparatus 10 comprises at least a presser mean that is pivoted to the support body 30.

The at least one presser mean is configured to assume, by means of rotation around the pivoting point, at least a first operating position, or reception position, in which the at least one presser mean and the support body 30 are configured to receive the scrap, and at least a second operating position, or compacting position, in which the at least one presser mean is moved near to the support body 30 to compact the scrap that is comprised between the support body 30 and the at least one presser mean.

In the case shown in the drawings, the pressing and compacting apparatus 10 comprises a first presser mean 12 and a second presser mean 14 configured to cooperate with each other and with the support body 30 in order to achieve the pressing and compacting of the loose mass 28 of scrap.

In accordance with possible variant embodiments, both the first presser mean 12 and the second presser mean 14 can be provided with a pressing surface 15, configured to go into contact with the loose mass 28 of scrap and press it to compact it.

In accordance with variant embodiments, described using FIG. 1, the first presser mean 12 can have an at least partly arched shape while the second presser mean 14 can have a linear shape in segments, for example L-shaped.

In accordance with variant embodiments in FIG. 1 and FIGS. 3-7, the first presser mean 12 can be pivoted to the support body 30, in the case shown here, to the base 16, by means of a first pivoting element 22, and the second presser mean 14 can be pivoted to the support body 30, in the case shown here, to the base 16, by means of a second pivoting element 24.

The first presser mean 12 and the second presser mean 14 are configured to both assume the reception position and compacting position to respectively receive and compact the scrap.

In accordance with another aspect of the present invention, the pressing and compacting apparatus 10 comprises at least an actuation member connected to the at least one presser mean and configured to move the latter near to/away from the support body 30.

In particular, the at least one actuation member is configured to take the at least one presser mean 12, 14 into the reception position and compacting position.

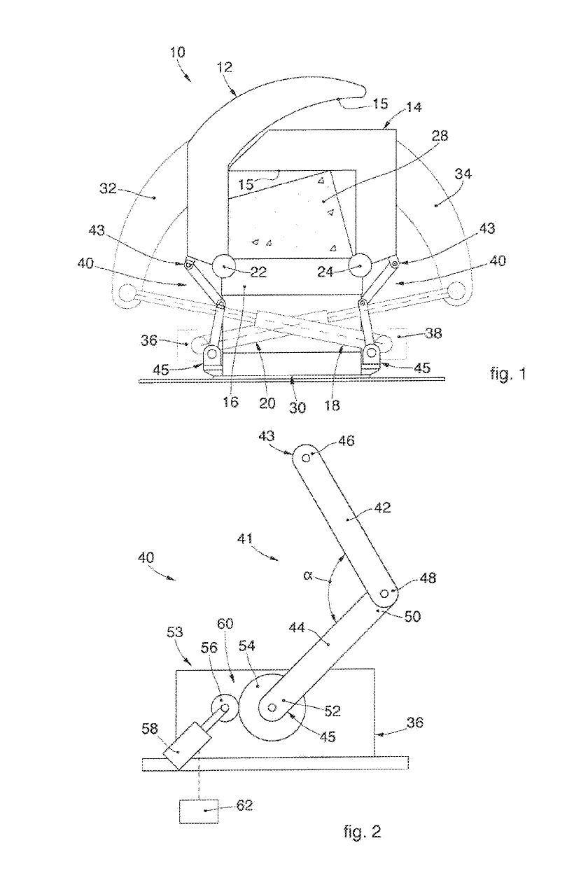

In accordance with variant embodiments shown in FIGS. 1-10, the pressing and compacting apparatus 10 comprises a first actuation member 18 and a second actuation member 20 to move respectively the first presser mean 12 and the second presser mean 14.

In accordance with possible embodiments, the at least one first actuation member 18 and the at least one second actuation member 20 can comprise linear actuators.

In accordance with variant embodiments, the pressing and compacting apparatus 10 can comprise a plurality of first actuation members 18 and a plurality of second actuation members 20. The number of first and second actuation members 18, 20 can be chosen on the basis of the compacting pressure to which the scrap is to be subjected.

In accordance with variant embodiments, the support body 30 can be provided with at least one support element, in this case a first support element 36 and a second support element 38, in correspondence with which the actuation members are pivoted, that is, the first actuation members 18 and the second actuation members 20.

The first actuation member 18 and the second actuation member 20 can be pivoted to the first support element 36 and to the second support element 38, so that their position can be adapted during the movement of the first presser mean 12 and the second presser mean 14.

Hereafter in the description the single form will be adopted for the at least one first actuation member 18 and for the at least one second actuation member 20, identifying them with the term “first actuation member” 18 and “second actuation member” 20, but it is understood that one or more of them can be provided.

In accordance with variant embodiments, the first actuation member 18 and the second actuation member 20 can be directly connected to the respective first presser mean 12 and second presser mean 14.

In accordance with variant embodiments, described using FIG. 1, the first presser mean 12 and the second presser mean 14 can be provided with a connection lever 32 and respectively 34 in correspondence to which the first actuation member 18 and the second actuation member 20 are respectively connected.

The connection levers 32 and 34 can be solidly connected to the first presser mean 12 and to the second presser mean 14.

The first actuation member 18 and the second actuation member 20 can be connected by pivoting to the respective connection levers 32 and 34.

In accordance with one aspect of the invention, the pressing and compacting apparatus 10 comprises at least a detection device 40 suitable to detect the position of the at least one presser mean, in the case shown here the first presser mean 12 and/or the second presser mean 14, during its passage from the reception position to the compacting position, and vice versa.

According to possible variant embodiments, at least one detection device 40 can conveniently be installed associated with the first presser mean 12, and at least one detection device 40 associated with the second presser mean 14.

Although hereafter we will describe the application of the detection device 40 to the first presser mean 12, a similar description can be provided for the application of the detection device 40 to the second presser mean 14.

In accordance with one aspect of the present invention, the detection device 40 comprises at least one connection mechanism 41 pivoted with its first end 43 to the presser mean 12 and with a second end to the support body 30, and at least an angular detection member 53 associated to the second end 45 to detect an angular travel 13 of the connection mechanism 41 during the movement of the first presser mean 12. Indeed in the passage of the first presser mean 12 from the reception position to the compacting position, and vice versa, the connection mechanism 41 is taken into rotation and drawn by the movement of the first presser mean 12.

The connection mechanism 41, according to embodiments not shown here, can be chosen from a group comprising an articulated mechanism, a telescopic mechanism, an elastic element, or a possible combination thereof.

In accordance with embodiments described with reference to FIGS. 1-10, the connection mechanism 41 comprises a first oblong element 42 and at least a second oblong element 44 pivoted with respect to each other and selectively rotatable around their reciprocal pivoting point.

Moreover, the first oblong element 42 is pivoted to the first presser mean 12 and the second oblong element 44 is pivoted to the support body 30, so that the first oblong element 42 and the second oblong element 44 are configured to make the connection mechanism 41 assume a univocal position for each position of the first presser mean 12.

In this way, during the movement of the first presser mean 12 the first oblong element 42 and the second oblong element 44 articulate with respect to each other and are taken into rotation around the pivoting points respectively with the first presser mean 12 and with the support body 30.

The first oblong element 42 and the second oblong element 44 can be conformed substantially as rods.

In accordance with a solution described with reference to FIGS. 1-10, a first terminal portion 46 of the first oblong element 42 is pivoted to the first presser mean 12, a second terminal portion 48 of the first oblong element 42 is pivoted to a first terminal portion 50 of the second oblong element 44, and a second terminal portion 52 of the second oblong element 44 is pivoted to the support body 30. This solution allows to define an articulated connection mechanism that during the movement of the first presser mean 12 determines an articulated movement of the first oblong element 42 and of the second oblong element 44.

According to this embodiment, the first terminal portion 46 of the first oblong element 42 defines the first end 43 of the connection mechanism 41 while the second terminal portion 52 of the second oblong element 44 defines the second end 45 of the connection mechanism 41.

In accordance with variant embodiments shown for example in FIGS. 1-10, the second terminal portion 52 of the second oblong element 44 can be pivoted, in a rotating manner, to the first support element 36, by means of the second terminal portion 52.

According to possible solutions, the angular detection member 53 is associated with the second terminal portion 52 of the second oblong element 44, in order to detect the angular travel of the second oblong element 44. As a function of the data detected by the angular detection member 53 it is possible to find the position assumed by the first presser mean 12 and therefore to know its position with respect to the support body 30.

In accordance with variant embodiments, the angular detection member 53 can comprise at least one revolution multiplier 60 attached solidly to the second end 45 of the connection mechanism 41, and at least one angular position transducer 58 connected to the revolution multiplier 60 and configured to detect the entity of rotation of the latter after the angular travel to which the second end 45 of the connection mechanism 41 is subjected during the rotation of the first presser mean 12.

The revolution multiplier 60 allows to increase the entity of rotation of the second end 45 so as to obtain an accurate and precise detection of the position of the latter, and consequently of the first presser mean 12.

In accordance with variant embodiments, the revolution multiplier 60 can comprise a first toothed wheel 54 solidly attached to the second terminal portion 52 of the second oblong element 44 and at least a second toothed wheel 56 kinematically connected to the first toothed wheel 54, in this case which engages directly on the first toothed wheel 54.

The second toothed wheel 56 is connected to the angular position transducer 58 which, as a function of the entity of angular rotation of the second toothed wheel 56 and the multiplication ratio of the revolution multiplier 60, allows to evaluate the position of the first presser mean 12.

The position assumed by the connection mechanism 41 is a direct consequence of the position assumed by the respective first presser mean 12, or second presser mean 14, connected to it. In particular, during the movement of the first presser mean 12, between the first oblong element 42 and the second oblong element 44 of the connection mechanism 41 an angle α is formed.

The first oblong element 42 and the second oblong element 44 are configured so that, whatever the position assumed by the first presser mean 12, between the first oblong element 42 and the second oblong element 44 a convex angle α is always defined, facing toward a same side of the first oblong element 42 and the second oblong element 44. This condition ensures that in the passage of the first presser mean 12 from its reception position to its compacting position there is no inversion of the direction of rotation of the second oblong element 44 and therefore there are non-univocal positions of the first oblong element 42 and the second oblong element 44 for each position assumed by the first presser mean 12.

According to a possible implementation, to detect the position assumed by the first presser mean 12, the angular detection member 53 can detect the angular travel 13 defined as the angular amplitude according to which the second oblong element 44 moves from the position where the first presser mean 12 is in the reception position to the position where it is in the compacting position.

In accordance with variant embodiments, described using FIG. 8, when the second oblong element 44 is in the position corresponding to the maximum opening of the first presser mean 12 (indicated with a dotted line in FIG. 8), the angular position transducer 58 can be set so as to detect a value of angle β equal to zero degrees, a value that increases in the direction indicated by the arrow F on the basis of the progressive closing of the first presser mean 12.

The angular position transducer 58 can comprise an angular or rotary encoder, for example a tachometric encoder, a relative or incremental encoder, or an absolute encoder.

Moreover, the angular position transducer 58 is advantageously configured to communicate with a control unit 62 to which the data relating to the angular position of the corresponding connection mechanism 41 are sent. The control unit 62 can be configured in its turn to calculate the position assumed by the first presser mean 12 knowing the constructive and dimensional parameters of the various components of the apparatus 10 and knowing the data detected by the angular detection member 53.

The control unit 62 can be configured to verify the correct execution of a scrap pressing and compacting method, comparing the values received from the at least one angular position transducer 58 in relation to the position of the first presser mean 12 and with pre-established and pre-set values.

In addition, the control unit 62 can be configured to activate/deactivate both the first actuation member 18 and the second actuation member 20, for example at the moment when the angular detection member 53 has detected that the first presser mean 12 has reached the reception position or the compacting position.

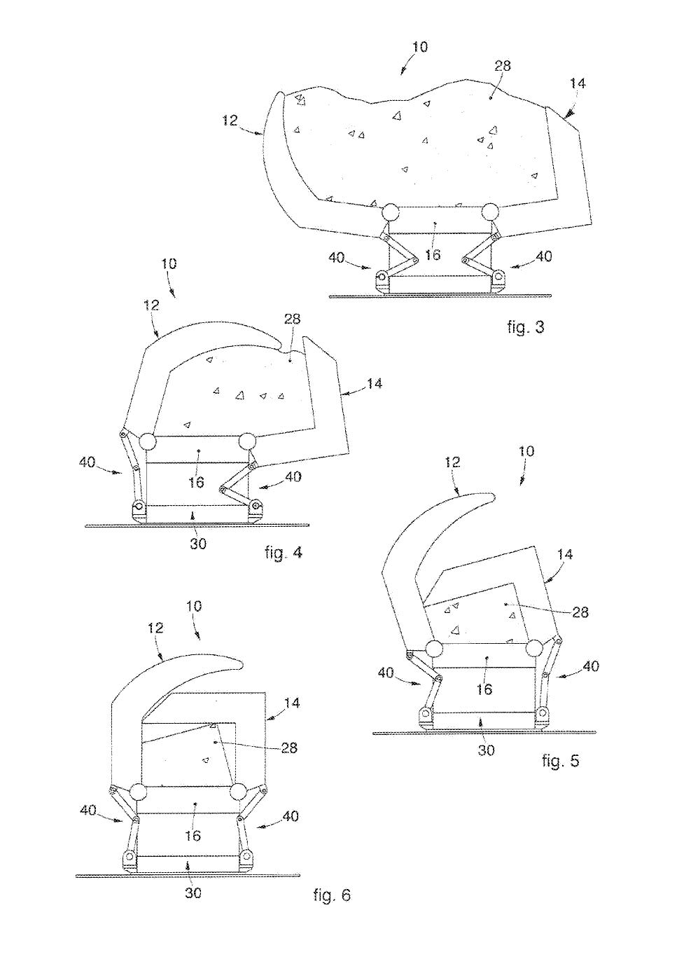

FIG. 3 shows a possible configuration of the detection devices 40 associated with the first presser mean 12 and the second presser mean 14 when the latter are in their reception position, that is in the position of maximum opening with respect to the support body 30.

In this position the incoherent mass of scrap 28 can be introduced between the first presser mean 12, the second presser mean 14 and the support body 30.

In FIG. 4, the first presser mean 12 is taken into its compacting position to compact the scrap comprised between the support body 30 and the first presser mean 12.

In FIG. 5, the first presser mean 12 is partly distanced from the support body 30 to allow to take the second presser mean 14 into its compacting position, and therefore to compact the mass 28 comprised between the support body 30 and the second presser mean 14.

In FIG. 6, the second presser mean 14 is partly distanced from the support body 30 and the first presser mean 12 is partly brought nearer the support body 30 so as to define a predefined shape of the compacted material.

In accordance with variant embodiments, described using FIGS. 9 and 10, the pressing and compacting apparatus 10 can comprise at least an end-of travel detector 70 configured to detect the limit positions of the connection mechanism 41 corresponding to the maximum closing and/or maximum opening of the first presser mean 12 and/or the second presser mean 14.

The sensor 72 can be placed in a fixed position, for example installed on the support body 30.

The end-of-travel detector 70 can comprise at least an abutment element 74 attached to the connection mechanism 41 in correspondence to its second end 45 and mobile with it, and a sensor 72 configured to detect the limit positions assumed by the second end 45 during the passage of the first presser mean 12 from the reception position to the compacting position.

In accordance with possible embodiments, the abutment element 74 can be attached to the second terminal portion 52 of the second oblong element 44.

In accordance with variant embodiments, described using FIG. 9, the abutment element 74 of the end-of-travel detector 70 can be, for example, a shaped element, for example a flange, configured to abut on the sensor 72, thus creating a mechanical type abutment.

Other embodiments can provide that the abutment element 74 has a shaped cam profile so as to present ridges or convexities in correspondence with the limit positions assumed by the second end 45 of the connection mechanism 41.

The sensor 72 can be configured to send a signal to the control unit 62, in the case wherein a contact with the abutment element 74 is verified, for example when the first presser mean 12 and the second presser mean 14 reach the reception position and the compacting position.

The control unit 62, as a function of the data detected by the angular detection member and by the sensor 72, is also able to determine anomalous functioning conditions of the pressing and compacting apparatus 10 according to the present invention, also giving possible alarm signals.

In accordance with other variant embodiments, described using FIG. 10, the abutment element 74 can comprise position indicators 76 suitable to be detected electrically by the sensor 72, in this way achieving an electric type abutment.

Advantageously, it is provided that the position indicators 76 are angularly fixed offset with respect to each other on the second end 45 of the connection mechanism 41, in suitable and coordinated positions to identify the position of maximum opening and maximum closing of the first presser mean 12 or of the second presser mean 14.

In accordance with other variant embodiments, the sensor 72 and the abutment element 74 can be of the optical or magnetic type.

It is clear that modifications and/or additions of parts may be made to the pressing and compacting apparatus 10 as described heretofore, without departing from the field and scope of the present invention.

It is also clear that, although the present invention has been described with reference to some specific examples, a person of skill in the art shall certainly be able to achieve many other equivalent forms of pressing and compacting apparatus 10, having the characteristics as set forth in the claims and hence all coming within the field of protection defined thereby.

1. Pressing and compacting apparatus comprising a support body, at least one presser mean pivoted to the support body, at least one actuation member connected to said presser mean and configured to move said presser mean toward/away from said support body, and at least one detection device associated to the presser mean to detect the angular position of said presser mean, wherein said detection device comprises at least one connection mechanism pivoted with a first end to said presser mean and with a second end to said support body, and at least one angular detection member associated to the second end to detect an angular travel of the connection mechanism during the movement of the at least one presser mean.

2. Pressing and compacting apparatus as in claim 1, wherein said connection mechanism comprises a first oblong element and at least one second oblong element pivoted to each other, and in that said first oblong element is pivoted to said presser mean and said second oblong element is pivoted to said support body, said first oblong element and said second oblong element being configured to make said connection mechanism assume a univocal position for each position of the presser mean.

3. Apparatus as in claim 2, wherein a first terminal portion of said first oblong element is pivoted to said presser mean, a second terminal portion of said first oblong element is pivoted to a first terminal portion of said second oblong element, and a second terminal portion of said second oblong element is pivoted to said support body.

4. Apparatus as in claim 3, wherein said angular detection member is associated to said second terminal portion of said second oblong element, in order to detect the angular travel of said second oblong element.

5. Apparatus as in any of the claims from 2, wherein said first oblong element and said second oblong element are configured so that, whatever the position assumed by said presser mean is, between said first oblong element and said second oblong element a convex angle is always defined, facing the same side of said first oblong element and said second oblong element.

6. Apparatus as in claim 1, wherein said angular detection member comprises at least one revolution multiplier attached solidly to said second end of the connection mechanism and at least one angular position transducer connected to said revolution multiplier and configured to detect the entity of rotation of the latter after the angular travel to which the second end of the connection mechanism is subjected during the rotation of said presser mean.

7. Apparatus as in claim 6, wherein said angular position transducer is configured to communicate with a control unit to which it sends the data concerning the angular position of said connection mechanism, and in that said control unit is configured to calculate the position assumed by said presser mean.

8. Apparatus as claim 1, wherein it comprises at least one end-of-travel detector configured to detect the limit positions of said connection mechanism corresponding with the maximum closing and/or maximum opening of said presser mean.

9. Apparatus as in claim 8, wherein said end-of-travel detector comprises at least an abutment element attached to said connection mechanism in correspondence to its second end and mobile with it, and a sensor configured to detect the limit positions assumed by the second end.

10. Method for pressing and compacting scrap that comprises:
the selective drive of at least one actuation member to rotate at least one pressure mean with respect to a support body and take it into a and into said presser mean, and into a compacting position suitable to compact said scrap between said presser mean and said support body; and
the detection of the position of the at least one presser mean wherein it comprises the detection of the angular travel of a connection mechanism pivoted with a first end to said presser mean and with a second end to said support body and, as a function of the angular travel assumed by said connection mechanism, calculating the position of said presser mean.
